(19) United States
(12) Patent Application Publication
(10) Pub. No.: US 2009/0038503 A1
(43) Pub. Date: Feb. 12, 2009

(54) Asphalt Release Agent and Method of Use

(76) Inventors: Dimmick L. Bymaster, Batesville, AR (US); Kenny Smith, Batesville, AR (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/836,466

(22) Filed: Aug. 9, 2007

(51) Int. Cl. C09D 7/02

(52) U.S. Cl. 106/2

(57) ABSTRACT

An asphalt release agent based on glycerin, and which may also contain water, a surfactant, and a biocide. The asphalt release agent inhibits asphalt concrete from adhering to containers, tools, and machinery while also being biodegradable, formed from a renewable resource, and generally nontoxic.

### BACKGROUND

1. Field of the Invention

The present invention relates to the field of asphalt release agents. In particular, the present invention relates to a biodegradable release agent primarily comprised of glycerin.

2. Description of the Related Art

Asphalt concrete, also commonly referred to simply as asphalt, is used to pave roads, sidewalks, driveways, parking lots, and any other surface that it is appropriate to pave with aggregate particles. It is also used in roofing shingles, fence post treatments, and waterproofing fabrics. Technically, asphalt is the mortar between the aggregate particles in the concrete; its “sticky” properties hold the particles together to make asphalt concrete by virtue of the fact that the asphalt is usually of an opposite pH from the aggregate. Asphalt is a refinement of the residue from distillation of certain crude oils, generally comprising naturally occurring bitumens or residues commonly obtained in petroleum, synthetic petroleum, or shale oil refining, or from coal tar, or the like, Bitumen is composed primarily of highly condensed polycyclic aromatic hydrocarbons.

Asphalt concrete is most commonly moved from the source to the location to be paved in trucks with large beds into which the asphalt is poured. Asphalt is generally laid with other machines and tools made primarily of metal. A problem inherent in the need to transport and lay asphalt is that the sticky asphalt concrete is prone to adhering to an unacceptable degree to the truck bed or other transport container, laying machines, tools, and other objects which are used to handle it. This results in wasted asphalt, damage and corrosion to the truck bed and other items, and a sticky mess that takes man-hours to clean up. The asphalt concrete is also abrasive, so it is desirable to insulate it from the truck bed or other items. These problems apply to any container in which asphalt concrete is stored for any period of time and any equipment used to spread, unload, or apply asphalt concrete.

Current solutions to this problem include spraying the truck bed or any other container or tool with what is commonly known in the art as a release agent. For the purposes of this disclosure, a truck bed will be used as an exemplary object to which a release agent may be applied. One of ordinary skill in the art, however, would understand how the release agent may be used on other tools or objects. The release agent coats the truck bed and effectively blocks the asphalt concrete from “sticking” to the truck bed. Because the release agent ultimately ends up in the environment with the asphalt concrete, its formula and effects are highly regulated by state departments of transportation and other agencies. In addition, the release agent must not interfere with the bonding and paving qualities of the asphalt concrete. Current environmental regulations require that the asphalt release agent not “cut” or dissolve materials from the asphalt itself to prevent the sticking, as that compromises the integrity of the asphalt concrete and/or leaches potentially hazardous materials from the asphalt concrete into the environment. When asphalt concrete is thus “stripped,” the action of water removes the asphalt's ability to bond to the aggregate particles, as the two components are usually of opposite pH. It is also desirable that the release agent be cost-effective.

While it is often not legally used, many release agents comprise some form of diesel oil. Diesel oil is combustible, contributes to smog, presents health and safety risks to workers, and increases the amount of regulation over diesel-based release agents. Diesel also contaminates the soil and groundwater where the asphalt was unloaded and applied. Diesel-based release agents are generally not biodegradable. In addition, diesel-based release agents deplete a precious natural resource, made more so by the politics surrounding oil distribution. Finally, diesel-based release agents often soften asphalt, in violation of many regulations, and create potholes if they come into contact with pavement.

Other current release agents may be described as “soap-like.” These agents also present pollution problems, in that many release pollutants such as phosphates, NTA, and EDTA into the environment. Many such pollutants are toxic to aquatic life. These soap-like release agents often contain carcinogenic compounds, making them dangerous for workers. In addition, these soap-like release agents are much less effective. The components of these release agents are also generally not derived from renewable resources.

There have been some inroads into the development of biodegradable release agents. Such agents are preferable because they can be dumped, sewered, or otherwise disposed of without harm to the environment, and they do not as severely deplete reserves of nonrenewable resources, Many biodegradable release agents, however, do not solve the problem of softening asphalt and causing potholes when they contact pavement. In addition, many biodegradable release agents separate out, and must be agitated or stirred prior to use in order to be effective. This introduces a tedious additional step to the process of laying asphalt.

Many current biodegradable release agents derived from soybeans, vegetable oils, and/or animal fats strip the asphalt, such that the asphalt is less effective and regulations are violated. This stripping by agents based on vegetable and animal byproducts also often generates an odor that is unpleasant for workers and that attracts insects, further worsening the workplace environment by introducing annoyance and a health hazard. Stripping also leaves behind a residue in the truck bed or container which must be cleaned up. It is therefore desirable for a biodegradable release agent to not strip the asphalt and to not generate such unwanted byproducts.

One release agent, disclosed in U.S. Pat. No. 6,486,249 (Dituro et al.), comprises polyvinyl alcohol, glycerin, and water, with optional wetting agents and surfactants. Dituro's release agent, however, does not effectively utilize glycerin as it uses glycerin only as a film modifier, plasticizer, and antifreeze and only in relatively small quantities. Instead, Dituro uses polymer film from polyvinyl alcohol film former as the actual release agent. It is desirable for a biodegradable release agent to maximize the extent to which it is derived from renewable resources, preferably byproducts which are inevitably generated in other processes and which therefore lower the release agent's cost of manufacturing.

It is therefore desirable for an effective, compliant release agent to not emit any toxins into the environment that harm either the ecology or workers; to be biodegradable; to not deplete any nonrenewable resources, particularly oil-based resources; and to not soften asphalt or damage pavement.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Described herein, among other things, is an asphalt release agent comprising: glycerin in an amount of about 50 to about 85 percent by weight; and water in an amount of about 15 to about 50 percent by weight. In an alternative embodiment, the amount of glycerin is between about 70 and about 85 percent by weight or between about 78 and about 82 percent by weight.

In an embodiment, the release agent further comprises a surfactant, such as but not limited to linear alkyl sulfonate, in an amount of from about 0 to 1% by weight. The release agent may also comprise a biocide, such as, but not limited to, sodium benzoate, in an amount of about 100 to about 700 ppm. In an alternative embodiment, the surfactant comprises 0.1-0.3 percent by weight and the biocide about 300 to about 500 ppm.

There is also described herein, a method of releasing asphalt concrete from a container comprising: having a container; coating the container with an asphalt releasing agent comprising more than 50 percent glycerin by weight; loading asphalt concrete into the container; and unloading the asphalt concrete from the container.

In various embodiments of the method, the amount of glycerin is between about 50 and about 85 percent by weight, between about 70 and about 85 percent by weight, and between about 78 and about 82 percent by weight.

In another embodiment of the method the asphalt release agent also comprises at least one of water, which may be present in an amount between about 15 to about 50 percent, a surfactant, which may be present in an amount of from 0 to about 1 percent by weight, or a biocide, which may be present in an amount of about 100 to about 700 ppm.

In another embodiment of this method, the amount of surfactant is between about 0.1 and about 0.3 percent by weight; the amount of glycerin is between about 78 and about 82 percent by weight; the amount of water is between about 18 and about 22 percent by weight; and the amount of biocide is between about 300 and about 500 ppm.

In various embodiments of the method the surfactant may be, but is not limited to linear alkyl sulfonate and the biocide may be, but is not limited to, sodium benzoate. The glycerin may derived as a byproduct from the manufacture of biodiesel fuel.

In a still further embodiment, the method further comprises diluting the asphalt release agent with water prior to the coating.

There is also described herein, an asphalt release agent comprising: glycerin in an amount of more than about 50 percent by weight of the release agent; a surfactant in an amount of less than about 0.3 percent by weight of the release agent; and a biocide in an amount of less than about 500 ppm of the release agent. The asphalt release agent may further comprise water in an amount of more than about 15 percent by weight of the release agent.

### DESCRIPTION OF PREFERRED EMBODIMENT(S)

The following detailed description illustrates by way of example and not by way of limitation. Described herein, among other things, are embodiments of release agents for asphalt. While the disclosure refers to release agents for asphalt, the disclosed agent may be used for the release of any adhesive substance for which it is effective, such as rubbers, plastics, heavy hydrocarbons, and asphalt composites with other materials. Where the term “asphalt” is used, it encompasses both these other adhesive substances and any of a variety of organic materials, known now or later discovered, which are solid or semi-solid at room temperature, gradually liquefy when heated, and in which the predominant constituents are naturally occurring bitumens or residues commonly obtained in petroleum, synthetic petroleum, or shale oil refining, or from coal tar, or the like.

Further, while the release agent's use will primarily be discussed in conjunction with inhibiting asphalt adhesion to a truck bed (such as the dump section of a dump truck), it would be understood by one of ordinary skill in the art that the release agent may be used on other tools and equipment utilized in laying asphalt including, but not limited to, paving machines, front end loaders and bulldozer blades, shovels, and other tools.

The base in the biodegradable release agent disclosed herein preferably is glycerin. Glycerin is also known as glycerol, propane-1,2,3-triol, 1,2,3-propanetriol, 1,2,3-trihydroxypropane, glyceritol, and glycyl alcohol, and generally has the chemical formula of C₃H₅(OH)₃. This glycerin serves not to modify, plasticize, or adsorb into other ingredients in the release agent, but rather as the base of the release agent and therefore is effectively the release material. In alternative embodiments, the base could be ethylene glycol, propylene glycol, 1,3-propanediol, diethylene glycol, triethylene glycol, or similar materials. However, most of these materials are currently less preferred as some of them are toxic and they can be more expensive to produce.

Glycerin operates as an effective base for an asphalt release agent because it forms a “non-stick” coating on underlying material and fails to bond with asphalt. Glycerin has a very low toxicity and is noncarcinogenic, and so is safe for workers and the environment: in fact, it is used in many food, medical, and personal care products. It is generally considered biodegradable, and does not harm or corrode the plastics and metals out of which most asphalt containers are made. In addition, glycerin is often produced as a previously discarded byproduct of biodiesel manufacturing; therefore having an asphalt release using relatively large amounts of glycerin provides an effective product, accomplishes the goal of having a release agent derived from a renewable resource and provides a product which is generally biodegradeable. The fact that it is a byproduct of a different process also achieves the stated goal of lowering the cost of the release agent disclosed herein. Given the popularity of biofuels, glycerin is currently a relatively common and easy-to-come-by material. As an added advantage, glycerin also operates as an antifreeze, allowing the asphalt release agent to be used at lower temperatures.

Due to these and other properties of glycerin, it is preferred that the resultant release agent (prior to any possible thinning) include at least 50% of glycerin by weight. It is generally preferred that the glycerin amount range from about 51 to 85% by weight; more preferably from 70 to 85%; and still more preferably from 78 to 82% by weight.

In an embodiment, the asphalt release agents disclosed herein may also contain other materials to increase its effectiveness. In an embodiment, the first of these materials may be a surfactant. The surfactant serves to lower the release agent's surface tension, which increases its spreadability and uniformity of application to hydrophobic surfaces and hydrophobic asphalt. In a further embodiment, such a surfactant may be a linear alkyl sulfonate, although any soluble surfactant known in the art that does not foam substantially may be used. It may be utilized in the preferred embodiment in the range from about 0 to 1% by weight; more preferably from 0.05 to 0.5%; and most preferably from 0.1 to 0.3%.

In an embodiment, the asphalt release agents disclosed herein may also contain a biocide to inhibit the growth of undesirable yeasts, bacteria, fungi, or other microorganisms in the asphalt release agent. In a further embodiment, such a biocide may be sodium benzoate, although any biocide that does not impact the agent's solubility in water known in the art may be used. It may be utilized in the preferred embodiment in the range from about 100 to 700 parts per million (ppm); more preferably from 200 to 600 ppm; and most preferably from 300 to 500 ppm.

In an embodiment, the release agent disclosed herein may contain water which may be used as a support or may be used to decrease the glycerin viscosity to ease the handling of the resultant release agent. Water may be utilized in the preferred embodiment in the range from 15 to 50%; more preferably from 15 to 25%; and most preferably from 18 to 22%. These amounts reflect proportions in undiluted release agent. Many release agents are often diluted with additional water immediately prior to their use to increase their effective coverage. Further, such dilution allows the release agent to be sold in what is effectively a concentrated form which is often more cost effective. It should be apparent that one undiluted form includes no water utilizing virtually 100% glycerin.

One preferred embodiment of the asphalt release agent disclosed herein has the following formula including all the above materials: 78-82% glycerin, 18-22% water, 0.1-0.3% surfactant, and 300-500 ppm biocide. This embodiment is merely exemplary and represents an embodiment of material as sold. After market, additional water may be added to the asphalt release agent to increase the relative concentration of water therein. It is contemplated that the components of the release agent disclosed herein may be present in amounts within a very large range after such additional water dilution and therefore this disclosure is focused on the concentrations in initial provided material, not the concentration of components in “after-market” dilution. However, there is no requirement that the release agent be diluted at all and may be used at its original concentration, or at a concentration where glycerin is still a majority (50% or greater) component of the release agent. All formulations discussed herein use glycerin as the base and it is expected that a formulation would not comprise less than 50% glycerin at the time the release agent is manufactured.

The application of the asphalt release agent disclosed herein is according to principles commonly known in the art. This may be by first diluting to achieve a desired concentration for the specific use, and then by spraying, brushing, dipping, or otherwise coating the material in contact with the asphalt concrete. Such dilution may take place at any point between manufacture and use, and may occur in multiple steps. Application may take place at any temperature commonly used in the art, with the additional advantage that the glycerin-based release agent disclosed herein remains operative at temperatures lower than the operative temperatures of current release agents. Once the asphalt release agent has been applied, asphalt would then be added to the container, would be taken to the use location and discharged. When used on tools, the release agent may be applied prior to the tool's use and reapplied as necessary during use. Since the asphalt release agent is generally not damaging to asphalt containers or tools, there may be no cleanup required. However, water may be used to remove the release agent if cleanup is required.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. An asphalt release agent comprising:
glycerin in an amount of about 50 to about 85 percent by weight; and
water in an amount of about 15 to about 50 percent by weight.

2. The release agent of claim 1 further comprising a surfactant in an amount of from about 0 to 1% by weight.

3. The release agent of claim 2 wherein said surfactant is a linear alkyl sulfonate.

4. The release agent of claim 2 further comprising a biocide in an amount of about 300 to about 500 ppm.

5. The release agent of claim 4 wherein:
said amount of surfactant is between about 0.1 and about 0.3 percent by weight;
said amount of glycerin is between about 78 and about 82 percent by weight; and
said amount of water is between about 18 and about 22 percent by weight.

6. The release agent of claim 5 wherein said biocide is sodium benzoate and said surfactant is linear alkyl sulfonate.

7. The release agent of claim 1 further comprising a biocide in an amount of from 100 to 700 ppm.

8. The release agent of claim 7 wherein said biocide is sodium benzoate.

9. The release agent of claim 1 wherein said amount of glycerin is between about 70 and about 85 percent by weight.

10. The release agent of claim 1 wherein said glycerin is between about 78 and about 82 percent by weight.

11. A method of releasing asphalt concrete from a container comprising:
having a container;
coating said container with an asphalt releasing agent comprising more than 50 percent glycerin by weight;
loading asphalt concrete into said container; and
unloading said asphalt concrete from said container.

12. The method of claim 11 wherein said amount of glycerin is between about 50 and about 85 percent by weight.

13. The method of claim 12 wherein said amount of glycerin is between about 70 and about 85 percent by weight.

14. The method of claim 13 wherein said amount of glycerin is between about 78 and about 82 percent by weight.

15. The method of claim 11 wherein said asphalt release agent also comprises water.

16. The method of claim 15 wherein said water is present in an amount between about 15 to about 50 percent.

17. The method of claim 16 wherein said asphalt releasing agent further comprises a surfactant in an amount of from 0 to about 1 percent by weight.

18. The method of claim 17 wherein said asphalt releasing agent further comprises a biocide in an amount of about 100 to about 700 ppm.

19. The method of claim 18 wherein said amount of surfactant is between about 0.1 and about 0.3 percent by weight; said amount of glycerin is between about 78 and about 82 percent by weight; said amount of water is between about 18 and about 22 percent by weight; and said amount of biocide is between about 300 and about 500 ppm.

20. The method of claim 19 wherein said surfactant is a linear alkyl sulfonate.

21. The method of claim 20 wherein said biocide is sodium benzoate.

22. The method of claim 11 wherein said glycerin is derived as a byproduct from the manufacture of biodiesel fuel.

23. The method of claim 11 further comprising diluting the said asphalt release agent with water prior to said coating.

24. An asphalt release agent comprising:
glycerin in an amount of more than about 50 percent by weight of the release agent;
a surfactant in an amount of less than about 0.3 percent by weight of the release agent; and
a biocide in an amount of less than about 500 ppm of the release agent.

25. The asphalt release agent of claim 24 further comprising water in an amount of more than about 15 percent by weight of the release agent.
